(19) United States
(12) Patent Application Publication
(10) Pub. No.: US 2025/0069577 A1
(43) Pub. Date: Feb. 27, 2025

(54) APPARATUS AND METHOD FOR INTELLIGENT ACTIVE NOISE CONTROL

(71) Applicant: HYUNDAI MOBIS CO., LTD., Seoul (KR)

(72) Inventor: Hyung Sub Lim, Suwon-si (KR)

(73) Assignee: HYUNDAI MOBIS CO., LTD., Seoul (KR)

(21) Appl. No.: 18/666,175

(22) Filed: May 16, 2024

(30) Foreign Application Priority Data
Aug. 22, 2023 (KR) 10-2023-0109667

(51) Int. Cl. G10K 11/178

(52) U.S. Cl. CPC G10K 11/17823; G10K 11/17827; G10K 11/17873; G10K 2210/12821; G10K 2210/3011; G10K 2210/30231; G10K 2210/3027; G10K 2210/3035

(57) ABSTRACT

An intelligent active noise control device according to an embodiment includes a microphone mounted in a vehicle and receiving in-vehicle noise, a noise of interest model configurer generating a noise of interest model by being trained on noise characteristics according to a preset type of noise, a similarity analysis and decision unit analyzing collected noise by comparing the collected noise with the noise model of interest, an active noise control area configurer setting an active noise control area according to an analyzed similarity, and an active noise control sound output unit outputting an active noise control sound to the set active noise control area.

### CROSS-REFERENCE TO RELATED APPLICATION(S)

This application is based on and claims priority under 35 U.S.C. § 119 to Korean Patent Application No. 10-2023-0109667, which was filed in the Korean Intellectual Property Office on Aug. 22, 2023, the entire disclosure of which is incorporated herein by reference.

### BACKGROUND

### 1. Field

The present embodiments relate to active noise control, and more particularly, to a vehicle to which a deep learning-based active noise control method is applied.

### 2. Description of Related Art

Vehicle manufacturers have made a lot of efforts to reduce in-vehicle noise. As part of these efforts, active noise control (ANC) methods have been introduced to reduce noise by generating a sound with the opposite phase of noise and superimposing it on the noise, in addition to passive methods such as adding or improving sound insulation or vibration dampening materials.

Recently, research has been conducted on how to apply these ANC methods to noise isolation between passengers in addition to controlling noise coming from outside the vehicle, such as road noise.

ANC systems use feedforward and feedback structures to attenuate unwanted noise and thus adaptively cancel the unwanted noise within a listening environment, such as inside a vehicle cabin. The ANC systems typically cancel or reduce unwanted noise by generating canceling sound waves to interfere with the unwanted audible noise in a canceling manner.

The conventional ANC systems measure noise and vibration data using acceleration/microphone sensors and diagnose noise using an algorithm of estimating them. For this purpose, however, a plurality of acceleration sensors and a plurality of microphones are attached to a vehicle, thereby increasing cost.

### SUMMARY

To solve the problems described above, an embodiment of the disclosure is intended to provide an intelligent active noise control (ANC) device for performing ANC without an acceleration sensor.

The problems to be solved by the disclosure are not limited to the technical problems mentioned above, and other technical problems not mentioned will be clearly understood by those skilled in the art from the following description.

To address the above-described problems, an intelligent active noise control device according to any one of embodiments of the disclosure includes a microphone mounted in a vehicle and receiving in-vehicle noise, a noise of interest model configurer generating a noise of interest model by being trained on noise characteristics according to a preset type of noise, a similarity analysis and decision unit analyzing collected noise by comparing the collected noise with the noise model of interest, an active noise control area configurer setting an active noise control area according to an analyzed similarity, and an active noise control sound output unit outputting an active noise control sound to the set active noise control area.

According to an embodiment, the noise of interest model configurer includes a noise input unit receiving at least one of road noise or living noise, a deep learning trainer performing deep learning training on the road noise and the living noise, and a noise of interest model generator generating at least one of a road noise model or a living noise model based on the deep learning training.

According to an embodiment, the similarity analysis and decision unit determines whether road noise is included in the collected noise by analyzing a similarity between the collected noise and the road noise model, and determines whether living noise is included in the collected noise by analyzing a similarity between the collected noise and the living noise model.

According to an embodiment, when the collected noise is similar to road noise, the active noise control area configurer configures the collected noise to be included in the active noise control area.

According to an embodiment, when the collected noise is similar to living noise, the active noise control area configurer configures the collected noise not to be included in the active noise control area.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an overall block diagram illustrating an autonomous driving control system to which an autonomous driving device according to any one of embodiments of the disclosure is applicable;

FIG. 2 is an exemplary diagram illustrating an example of applying an autonomous driving device according to any one of embodiments of the disclosure to an autonomous vehicle;

FIGS. 3 to 6 are diagrams illustrating an intelligent active noise control (ANC) device according to an embodiment of the disclosure;

FIGS. 7 and 8 are diagrams illustrating a method of changing a weighted parameter in an intelligent ANC method according to an embodiment of the disclosure;

FIG. 9 is a diagram illustrating the configuration of an intelligent ANC logic according to an embodiment of the disclosure; and

FIG. 10 is a flowchart illustrating an intelligent ANC method according to embodiments of the disclosure.

### DETAILED DESCRIPTION

Hereinafter, embodiments of the present disclosure will be described in detail with reference to the accompanying drawings so that those skilled in the art to which the present disclosure pertains may easily implement the present disclosure. However, the present disclosure may be implemented in various different forms and is not limited to the embodiments described herein. In addition, in order to clearly describe this disclosure in drawings, parts unrelated to the description are omitted and similar reference numbers are given to similar parts throughout the specification.

Throughout the specification, when a part “includes” a certain component, this means that it may further include other components, rather than excluding other components, unless otherwise stated.

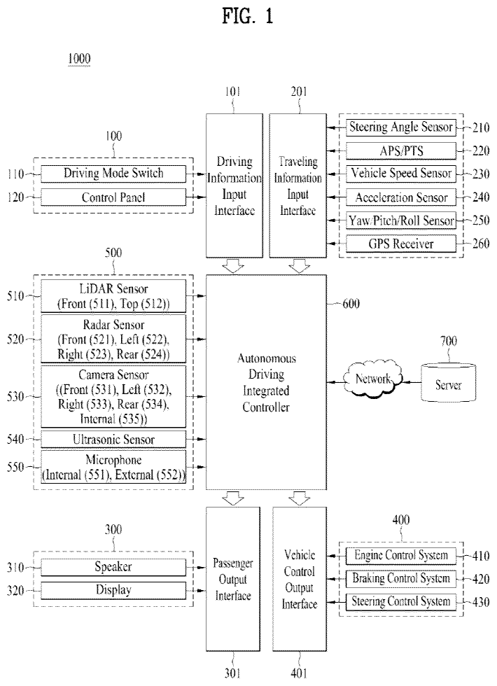

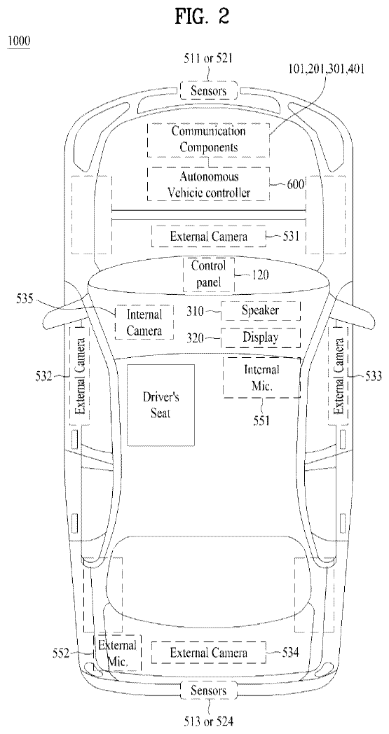

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

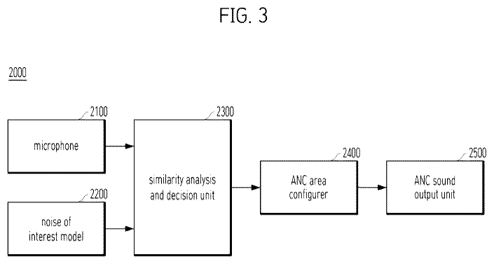

FIGS. 3 to 6 are diagrams illustrating an intelligent active noise control (ANC) device according to an embodiment of the disclosure.

Referring to FIGS. 3 to 6, an intelligent ANC device 2000 may include a microphone 2100, a noise of interest model configurer 2200, a similarity analysis and decision unit 2300, an ANC area configurer 2400, and an ANC sound output unit 2500 (e.g., a speaker).

The microphone 2100 may be mounted within a vehicle to collect in-vehicle noise.

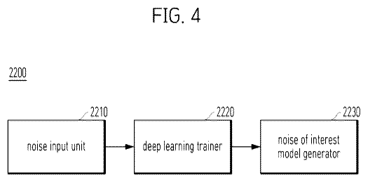

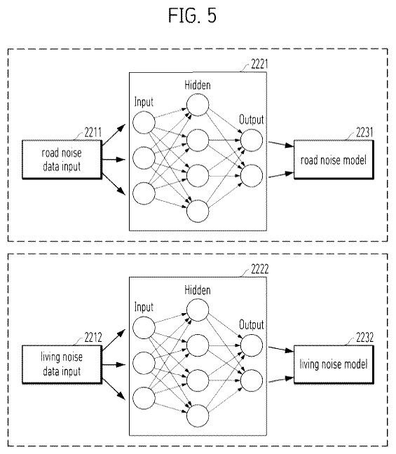

The noise of interest model configurer 2200 may include a noise input unit 2210, a deep learning trainer 2220, and a noise of interest model generator 2230, as illustrated in FIGS. 4 and 5. The noise of interest model configurer 2200 may be pre-implemented to implement an intelligent ANC method.

The noise input unit 2210 may receive at least one of road noise data 2211 or living noise data 2212. Noise may be a recorded sound. Road noise may be a recording of various road noises from various roads and actual vehicle driving, and living noise may be a recording of various general living noises. The living noises may include a wide range of sounds, such as conversational sound, music sound, weather-related sound, and the like.

The deep learning trainer 2220 may include a first deep learning trainer 2221 that receives road noise data and performs training, and a second deep learning trainer 2221 that receives living noise data and performs training.

The deep learning trainer 2220 may include a neural network and other derivative algorithms. Further, a learning structure may be replaced with any other effective data mining and machine learning method. As training of the deep learning trainer 2220 progresses, hidden layers of deep learning may continue to be reconstructed and updated.

The noise of interest model generator 2230 may generate a road noise model 2231 by the first deep learning trainer 2221 trained on the road noise data 2211 and a road noise model 2233 by the second deep learning trainer 2222 trained on the living noise data 2212.

The similarity analysis and decision unit 2300 may compare in-vehicle noise received from the microphone 2100 with a noise of interest model in the noise of interest model configurer 2200 to determine whether road noise or living noise is included in the in-vehicle noise. The similarity analysis and decision unit 2300 may perform similarity analysis and decision in the time domain and the frequency domain.

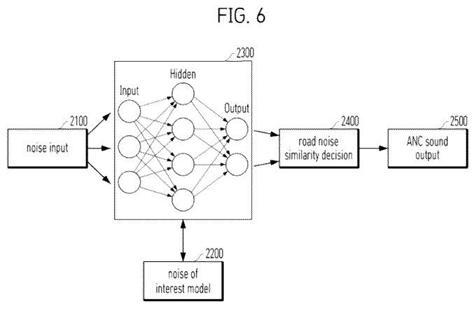

The similarity analysis and decision unit 2300 may perform the similarity analysis and decision based on deep learning. The similarity analysis and decision unit 2300 may include a neural network and other derivative algorithms, as illustrated in FIG. 6. A learning structure may also be replaced by any other effective data mining and machine learning method. As the training of the deep learning trainer 2220 progresses, the hidden layers of deep learning may continue to be reconstructed and updated.

The ANC area configurer 2400 may configure an ANC area based on a decided similarity.

The ANC sound output unit 2500 may output an ANC sound according to the result of the configuration.

According to an embodiment, the ANC sound output unit 2500 may output an ANC sound by including input noise in a control area, when the input noise is road noise.

According to an embodiment, the ANC sound output unit 2500 may output an ANC sound without including input noise in the control area, when the input noise is living noise.

According to an embodiment, when the input noise is not included in the control area, the ANC sound output unit 2500 may output the ANC sound by changing the control area configuration or a weighted parameter according to a system.

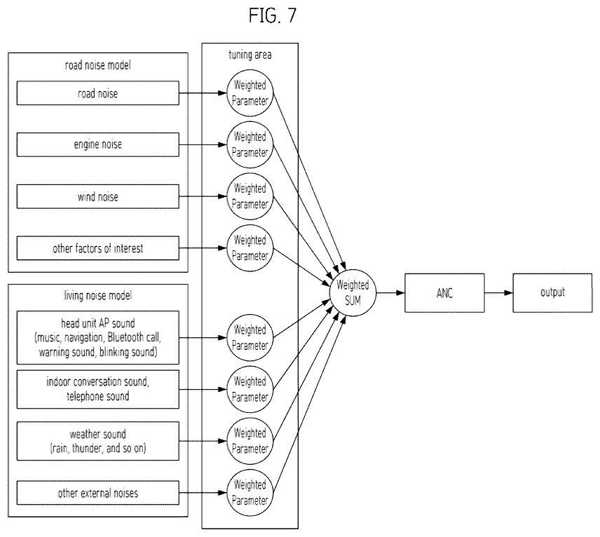

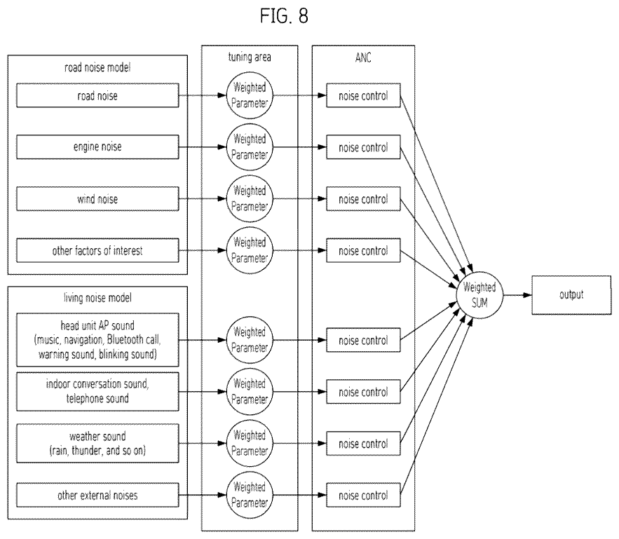

FIGS. 7 and 8 are diagrams illustrating a method of changing a weighted parameter in an intelligent ANC method according to an embodiment of the disclosure.

Referring to FIG. 7, the road noise model 2231 applied to the intelligent ANC device 2000 may include models of road noise, engine noise, wind noise, and other factors of interest.

The living noise model 2232 may include models of head unit AP sound (music, navigation, Bluetooth call, warning sound, and blinking sound), indoor conversation sound, telephone sound, weather sound (rain, thunder, and so on), and other external noises.

The intelligent ANC device 2000 may set weighted parameters for tuning areas based on each of the road noise model 2231 and the living noise model 2232.

The intelligent ANC device 2000 may perform ANC by a weighted sum of the set weighted parameters of the tuning areas and output an ANC sound.

Referring to FIG. 8, the road noise model 2231 applied to the intelligent ANC device 2000 according to a second embodiment may include models of road noise, engine noise, wind noise, and other factors of interest.

The living noise model 2232 may include models of head unit AP sound (music, navigation, Bluetooth call, warning sound, and blinking sound), indoor conversation sound, telephone sound, weather sound (rain, thunder, and so on), and other external noises.

The intelligent ANC device 2000 may set weighted parameters for tuning areas based on each of the road noise model 2231 and the living noise model 2232.

The intelligent ANC device 2000 may perform noise control in correspondence with the set weighted parameters of the tuning areas.

The intelligent ANC device 2000 may output an ANC sound by the weighted sum of the noise controls.

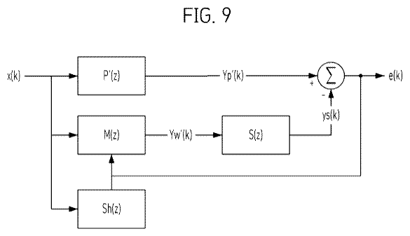

FIG. 9 is a diagram illustrating the configuration of an intelligent ANC logic according to an embodiment of the disclosure.

Referring to FIG. 9, the intelligent ANC device 2000 may convert a noise signal x(k) into a microphone signal P′(z) by using the microphone, and accordingly, generate a noise signal Yp′(k) to which microphone noise is added.

Then, the intelligent ANC device 2000 may generate a noise signal Yw′(k) from the noise signal x(k) by a deep learning-based controller M(z), and generate an ANC output value ys(k) by applying the signal Yw′(k) to a secondary path transfer function S(z) between a speaker and the microphone.

Then, the intelligent ANC device 2000 may generate a corrected noise signal e(k) based on the noise signal Yp′(k) to which the microphone noise is added and the ANC output value ys(k).

Then, the intelligent ANC device 2000 may perform ANC by repeating generation of the noise signal Yw′(k) from the noise signal e(k) corrected by using the deep learning-based controller M(z) and a controller correlation coefficient Sh(z) estimated by a second pass transfer function value, by the deep learning-based controller.

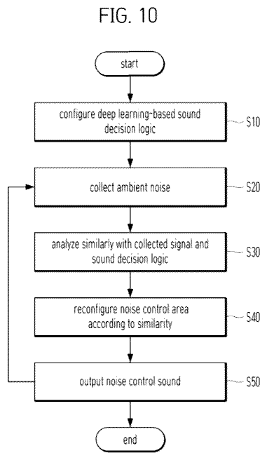

FIG. 10 is a flowchart illustrating an intelligent ANC method according to embodiments of the disclosure.

Referring to FIG. 10, the intelligent ANC device 2000 may configure a sound decision logic using at least one of a preset road noise deep learning model or a living noise deep learning model (S10).

After operation S10, the intelligent ANC device 2000 may collect ambient noise through the microphone (S20).

After operation S20, the intelligent ANC device 2000 may perform similarity analysis with the collected signal and the sound decision logic (S30).

After operation S30, the intelligent ANC device 2000 may reconfigure a noise control area based on a similarity (S40).

After operation S40, the intelligent ANC device 2000 may output a noise control sound based on the noise control area (S50).

According to any one of embodiments of the disclosure, there is an effect of reducing cost by implementing an ANC device system without an acceleration sensor.

According to any one of embodiments of the disclosure, as an intelligent ANC decision logic is improved, the existing noise control effect is increased.

That is, the technical idea of the disclosure is applicable to an autonomous vehicle as a whole, or to a partial configuration inside an autonomous vehicle. The scope of the disclosure is to be determined based on the appended claims.

In another aspect of the disclosure, the above-described proposals or inventive operations may also be provided as code that can be implemented, performed, or executed by a “computer” (a broad concept covering a system on chip (SoC) or a microprocessor), or as an application, a non-transitory computer-readable storage medium, or a computer program product storing or including the code, which also falls within the scope of the disclosure. For example, the above-described noise of interest model configurer, similarity analysis and decision unit, and active noise control area configurer may be implemented by one or more processors or microprocessors. The one or more processors or microprocessors, when executing the code stored in the non-transitory computer-readable storage medium, may be configured to perform the above-described operations.

A detailed description of the preferred embodiments of the disclosure set forth above has been provided to enable those skilled in the art to implement and practice the disclosure. While the above description has been made with reference to the preferred embodiments of the disclosure, it will be understood by those skilled in the art that various modifications and changes can be made to the disclosure without departing from the scope of the disclosure. For example, those skilled in the art may use configurations in the above-described embodiments in combination with each other.

Accordingly, the disclosure is not intended to be limited to the embodiments set forth herein, but rather to give the broadest possible scope consistent with the principles and novel features disclosed herein.

What is claimed is:

1. An intelligent active noise control device comprising:
a microphone mounted in a vehicle and collecting in-vehicle noise;
a noise of interest model configurer generating a noise of interest model by being trained on noise characteristics according to a preset type of noise;
a similarity analysis and decision unit analyzing collected noise by comparing the collected noise with the noise model of interest;
an active noise control area configurer setting an active noise control area according to an analyzed similarity; and
an active noise control sound output unit outputting an active noise control sound to the set active noise control area.

2. The intelligent active noise control device of claim 1, wherein the noise of interest model configurer includes:
a noise input unit receiving at least one of road noise or living noise;
a deep learning trainer performing deep learning training on the road noise and the living noise; and
a noise of interest model generator generating at least one of a road noise model or a living noise model based on the deep learning training.

3. The intelligent active noise control device of claim 2, wherein the similarity analysis and decision unit determines whether the road noise is included in the collected noise by analyzing a similarity between the collected noise and the road noise model, and determines whether the living noise is included in the collected noise by analyzing a similarity between the collected noise and the living noise model.

4. The intelligent active noise control device of claim 3, wherein when the collected noise is similar to the road noise, the active noise control area configurer configures the collected noise to be included in the active noise control area.

5. The intelligent active noise control device of claim 3, wherein when the collected noise is similar to the living noise, the active noise control area configurer configures the collected noise not to be included in the active noise control area.

6. An intelligent active noise control method comprising:
collecting in-vehicle noise;
generating a noise of interest model by being trained on noise characteristics according to a preset type of noise;
analyzing collected noise by comparing the collected noise with the noise model of interest;
setting an active noise control area according to an analyzed similarity; and
outputting an active noise control sound to the set active noise control area.

7. The intelligent active noise control method of claim 6, wherein generating a noise of interest model comprises:
receiving at least one of road noise or living noise;
performing deep learning training on the road noise and the living noise; and
generating at least one of a road noise model or a living noise model based on the deep learning training.

8. The intelligent active noise control method of claim 7, wherein analyzing collected noise by comparing the collected noise with the noise model of interest comprises:
determining whether the road noise is included in the collected noise by analyzing a similarity between the collected noise and the road noise model; and
determining whether the living noise is included in the collected noise by analyzing a similarity between the collected noise and the living noise model.

9. The intelligent active noise control method of claim 8, wherein setting an active noise control area according to an analyzed similarity comprises, when the collected noise is similar to the road noise, configuring the collected noise to be included in the active noise control area.

10. The intelligent active noise control method of claim 8, wherein setting an active noise control area according to an analyzed similarity comprises, when the collected noise is similar to the living noise, configuring the collected noise not to be included in the active noise control area.
